(19) United States
(12) Patent Application Publication
(10) Pub. No.: US 2002/0056583 A1
(43) Pub. Date: May 16, 2002

(54) Apparatus for controlling vehicle driving force

(75) Inventors: Yoshiya Takano, Hitachinaka-shi (JP); Yoshiyuki Yoshida, Hitachinaka-shi (JP); Hidefumi Iwaki, Hitachinaka-shi (JP)

Correspondence Address: CROWELL & MORING, LLP, Intellectual Property Group, P.O. Box 14300, Washington, DC, 20044-4300, US

(73) Assignee: Hitachi, Ltd.

(21) Appl. No.: 10/038,662

(22) Filed: Jan. 8, 2002

Related U.S. Application Data
(63) Continuation of application No. 09/409,993, filed on Sep. 30, 1999.

(30) Foreign Application Priority Data
Sep. 30, 1998 (JP) 10-276948

(51) Int. Cl. B60K 5/00

(52) U.S. Cl. 180/197; 701/70; 701/69

(57) ABSTRACT

The apparatus for controlling vehicle driving force is provided with a target driving force deciding part for deciding a target driving force by using an accelerator opening and vehicle speed, and driving force distribution control part for distributing the target driving force to an engine torque control part and a drive system control part. Further, this apparatus has a vehicle running state determining part for detecting the running state of the vehicle. Furthermore, the final target driving force is increased or decreased to correct based on the result of the vehicle running state determining part in the target driving force deciding part or the driving force distribution control part.

### BACKGROUND OF THE INVENTION

The present invention relates to apparatus for controlling vehicle driving force, and particularly to the controller by which the vehicle driving force is controlled in consideration of the specific state of a vehicle or the environment state.

In the prior art, for instance, the Japanese Patent Application Laid-Open No. 10-148147 discloses a method of changing the characteristics of the driving force by detecting the current position of the vehicle. The switch of the vehicle driving force is performed when the driver does not operate the accelerator, in order to exclude driver's sense of incompatibility and the sudden change of the vehicle according to the driving force change.

In the above-mentioned prior art, the driving force can be unconditionally determined when a regional attribute is decided. The running due to the best fuel consumption characteristic of the vehicle is not considered. The purpose to control driving force is, as described in the above-mentioned prior art, to obtain the best fuel consumption performance from running decided by the parameter of the vehicle, in addition to demonstrate an excellent function of the running-characteristic adjusting part enough. Therefore, it is not necessarily satisfied to decide unconditionally the target driving force only by the regional attribute.

On the other hand, when an excellent function of the running quality adjusting part mentioned above is drawn out enough, interference (a contradiction point) with the driving force control is occurred. More concretely, the vehicle behavior enters into a more unstable state when slipping etc. occur with driving force being secured. The same thing is similarly generated in the rapid steering change and the rapid turn, etc. It is preferable to control in a direction where driving force is controlled in such a state of the vehicle.

From the above-mentioned situations, they are preferable that:

(1) the best driving force suitable to the vehicle parameter is set, and the best driving force is secured;

(2) when a running state of the vehicle is changed in a vehicle running determination, the vehicle behavior is controlled in a direction of stability rather than the best driving force; and/or

(3) more than the normal driving force is secured in a specific operating state.

### SUMMARY OF THE INVENTION

The apparatus for controlling vehicle driving force according to the present invention is provided with a target driving force deciding part for deciding a target driving force by using an accelerator opening and vehicle speed, and driving force distribution control part for distributing the target driving force to an engine torque control part and a drive system control part. Further, the present invention has a vehicle running state determining part for detecting the running state of the vehicle. Furthermore, in the present invention, the final target driving force is increased or decreased to correct based on the result of the vehicle running state determining part in the target driving force deciding part or the driving force distribution control part.

The target driving force is set so as to be suitable to the vehicle, and is used as a normal driving force control. This corresponds to the above-mentioned (1).

In the vehicle running state determining part, it is determined whether to have to follow the normal target driving force by determining the current vehicle state. If it is determined that the vehicle is in a specific operating state in the vehicle running state determining part, the vehicle behavior may become unstable. In such a case, the target driving force is decreased and the vehicle is induced in a direction of stability. This corresponds to the above-mentioned (2).

Further, the target driving force is increased by a predetermined amount to facilitate the accelerator operation when running the slope. As a result, stronger driving force is obtained to facilitate the operation of the vehicle. This corresponds to the above-mentioned (3).

### BRIEF DESCRIPTION OF THE DRAWINGS

FIG. 1 is an illustration of one embodiment of the present invention.

FIG. 2 is an illustration of the whole control according to one embodiment of the present invention.

FIG. 3 is an illustration of the vehicle state control according to one embodiment of the present invention.

FIG. 4 is an illustration of the vehicle state control according to one embodiment of the present invention.

FIG. 5 is an illustration of the vehicle state control according to one embodiment of the present invention.

FIG. 6 is an illustration of the vehicle state control according to one embodiment of the present invention.

FIG. 7 is an illustration of the vehicle state control according to one embodiment of the present invention.

FIG. 8 is an illustration of the vehicle state control according to one embodiment of the present invention.

FIG. 9 is an illustration of the vehicle state control according to one embodiment of the present invention.

FIG. 10 is a block diagram showing the calculation of engine torque from driving force.

FIG. 11 is a block diagram showing the calculation of CVT (Continuously Variable Transmission) target input number of revolutions from driving force.

FIG. 12 is a flow chart corresponding to FIG. 3.

FIG. 13 is a flow chart corresponding to FIG. 4.

FIG. 14 is a flow chart corresponding to FIG. 5.

FIG. 15 is a flow chart corresponding to FIG. 6.

FIG. 16 is a flow chart corresponding to FIG. 7.

FIG. 17 is a flow chart corresponding to FIG. 8.

FIG. 18 is an explanation view of the content of correction control.

FIG. 19 is a timing chart of transition control.

FIG. 20 is a flow chart of the transition control.

FIG. 21 is an illustration of the whole control according to another embodiment of the present invention.

FIG. 22 is a block diagram showing the calculation of the driving force according to the embodiment shown in FIG. 21.

### DETAILED DESCRIPTION OF THE PREFERRED EMBODIMENTS

Hereinafter, one embodiment of the apparatus for controlling vehicle driving force according to the present invention will be explained in detail with reference to the drawings.

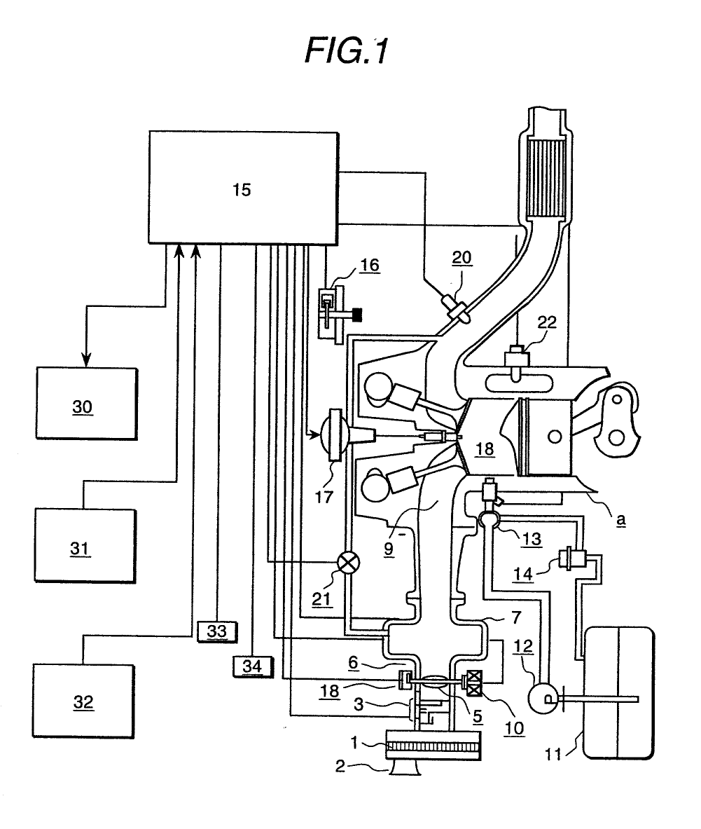

FIG. 1 shows one example of the engine system to which the present invention is applied. In FIG. 1, the intake air to the engine is taken from an entrance 2 of an air cleaner 1. The intake air passes through a throttle valve body 6 provided with a throttle valve 5 for controlling the amount of the intake air, and enters collector 7. Here, the throttle valve 5 is connected with a motor that operates the throttle valve. The amount of the intake air is adjusted by driving the motor 10.

The intake air arrived at collector 7 is distributed to each intake pipe 9 connected with each cylinder of the engine 8, and led in the cylinder.

On the other hand, after the fuel such as gasoline is sucked from an fuel tank 11 by an fuel pump 12, and pressurized, the fuel is supplied to the fuel system where a fuel injection valve 13 and a fuel pressure regulator 14 are provided. The pressure of the fuel is governed to the predetermined pressure by the fuel pressure regulator 14. The governed fuel is injected from the fuel injection valve 13 of which entrance is opened into each cylinder to the cylinder 18. Further, a signal indicative of the intake air amount is output from an air flow meter 3, and input to a control unit 15.

Further, a throttle valve sensor 18 for detecting the opening of the throttle valve 5 is installed in the throttle valve body 6. The output of the throttle valve sensor 18 is also input to the control unit 15.

Next, reference numeral 16 designates a crank angle sensor. It is rotated by a camshaft, and outputs a signal indicative of the rotation position of the crankshaft. This signal is also input to the control unit 15.

Reference numeral 20 designate an A/F (air fuel ratio) sensor mounted on an exhaust pipe. The A/F sensor detects and outputs the air fuel ratio of the actual operation from the components of the exhaust gas. Similarly, the air fuel ratio signal is input to the control unit 15. Reference numeral 22 designates a sensor for sensing the temperature of the engine coolant. An output of the sensor is also input to the control unit 15.

The control unit 15 inputs signals from various sensors for detecting the operating state of the engine, and carries out the predetermined operation processing. The control unit 15 outputs the result of the predetermined operation to the fuel injection valve 13, the fuel pressure regulator 14, the ignition coil 17 and the motor 10 for the drive of the throttle valve, to perform the fuel supply control, the ignition timing control and the intake air amount control. Further, the control unit 15 outputs a predetermined control signal to an EGR valve 21 to perform the exhaust gas circulation control.

In addition, an output of a steering angle sensor 33 for detecting the steering angle of a vehicle and an output of a yaw sensor 34 for detecting the turn movement around the center of gravity of the vehicle are input to the control unit 15.

The above-mentioned engine control unit 15 exchanges signals between other control units. In one embodiment of the present invention, the control unit 15 exchanges signals among a CVT control unit 30 for controlling a drive system, a TCS control unit 31 for performing the slip control and ASCD control unit 32 for performing a constant cruise control.

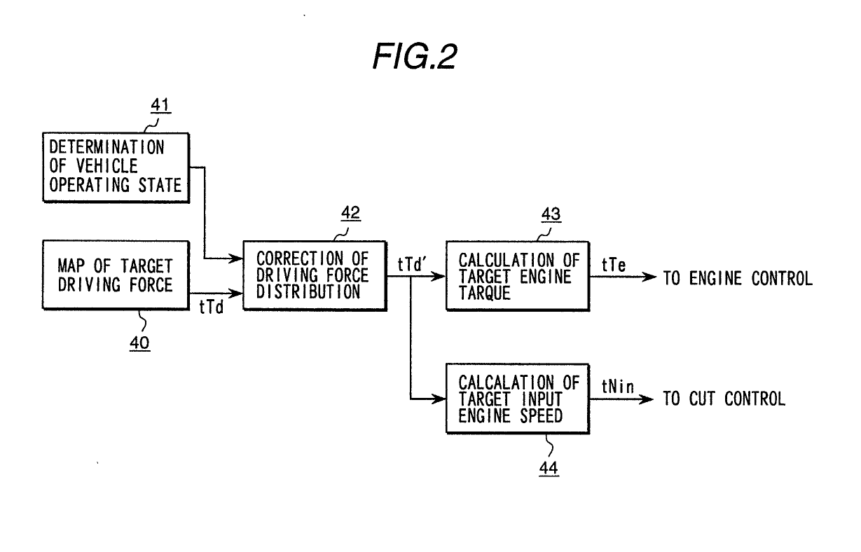

Next, the control of the driving force will be explained with reference to FIG. 2.

This control is achieved by the operation in the control unit 15.

The target driving force tTd is decided by using target driving force map 40. This target driving force is corrected by a driving torque distribution correction part 42 according to the result of the vehicle operating state determining part 41, and the final target driving force tTd′ is calculated. Next, the target engine torque tTe is calculated in block 43 where the target engine torque is calculated, based on the final target driving force tTd′. The tTe is realized in the engine control part described above.

On the other hand, the continuously variable transmission is used in the embodiment of the present invention. The number of the target input revolutions of the CVT is calculated in block 44 based on the final target driving force tTd′, and controlled to become a predetermined number of the input revolutions. This control can be performed directly from the control unit or from the CVT control unit as in the present invention.

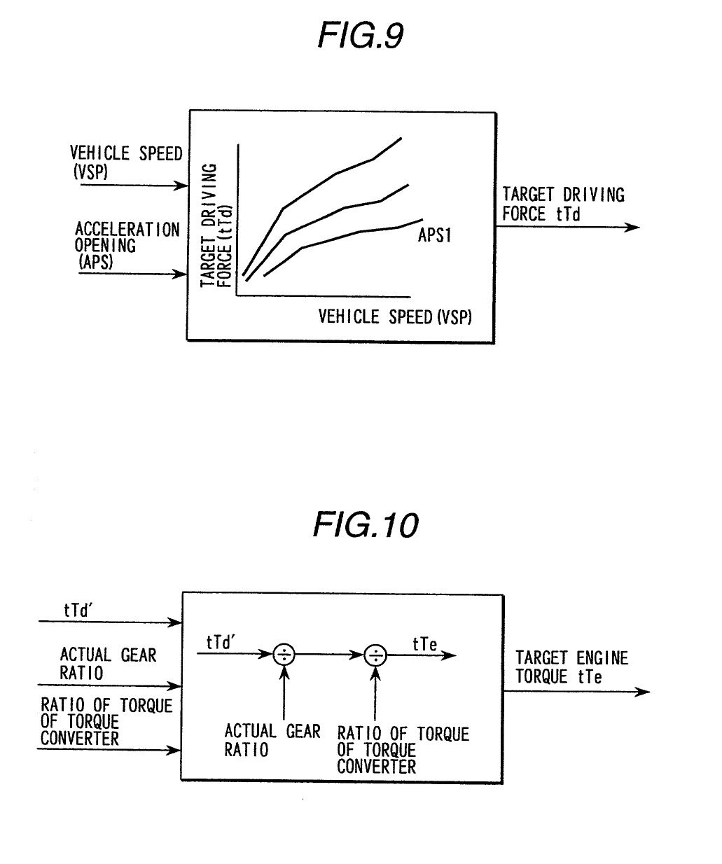

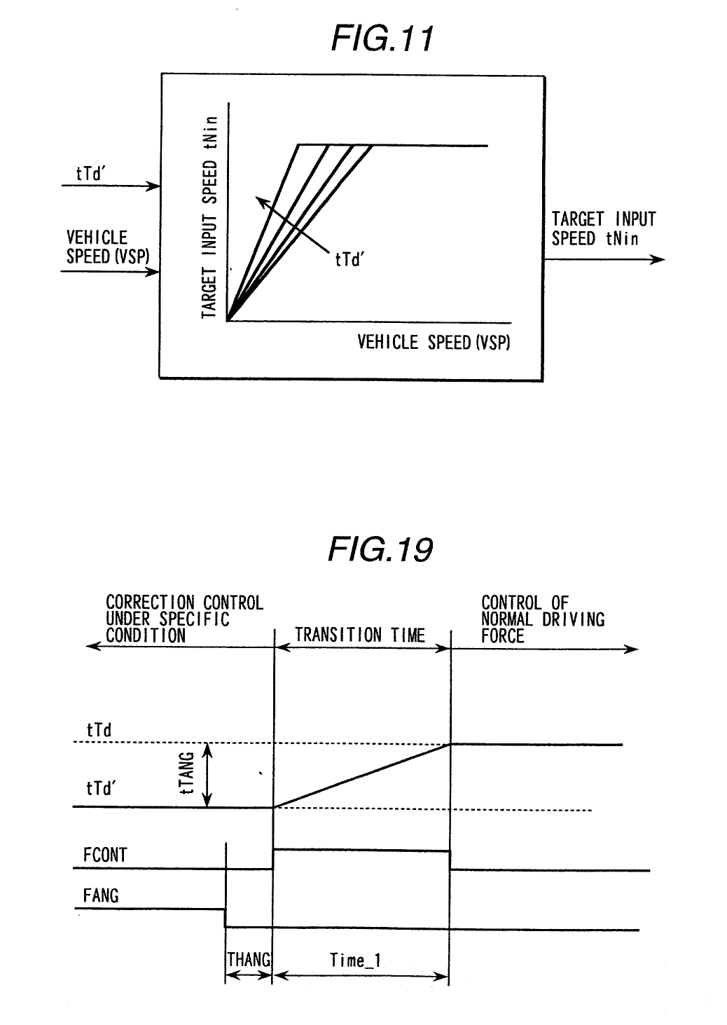

The map of the target driving force in block 40 will be explained in detail with reference to FIG. 9.

The tTd is retrieved from the target driving force map based on the vehicle speed and the accelerator opening.

Next, details of the calculation block 43 of the target engine torque tTe will be explained with reference to FIG. 10.

By dividing the final target driving force tTd′ by the parameter characteristic of the vehicle and the actual gear ratio decided based on the running state of the vehicle, and by dividing the quotient by the torque ratio of the torque converter, the engine torque tTe corresponding to the final target driving force tTd′ can be calculated. In the engine control unite 15, the fuel injection amount, the air flow amount, etc. are controlled so as to aim at the target engine torque tTe.

With regard to the control of the drive system according to the embodiment of the present invention, the number of the target input revolutions is calculated by using the final target driving force tTd′ and the vehicle speed, and controlled in the CVT control unit 30.

Next, the vehicle operating state determining block 41, a major part of the present invention will be explained in detail.

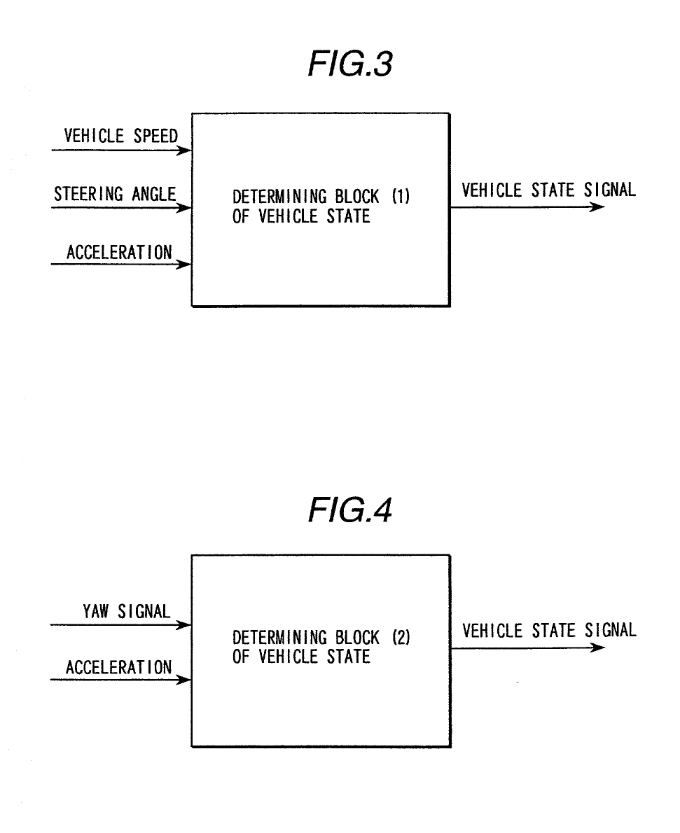

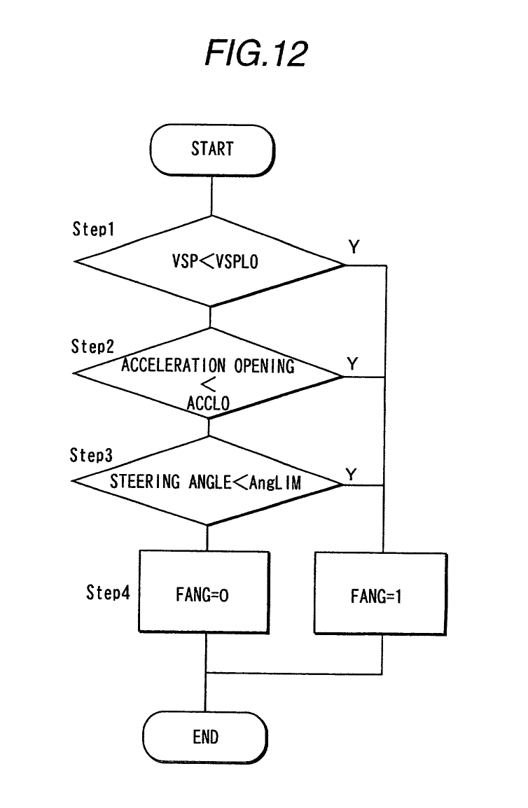

FIG. 3 shows one embodiment of the present invention. In this embodiment, the rapid steering wheel operation of the vehicle is detected as the vehicle operating state, and the target driving force is corrected with respect to the detected result. The vehicle speed, the steering angle and the opening of the accelerator are input to the determination block, and the vehicle state is determined based on these inputs. A concrete example of the determination is shown in FIG. 12. The condition to correct the driving force with respect to the rapid steering wheel operation of the vehicle should be assumed to be the condition by which the vehicle behavior is made unstable by the rapid steering wheel operation. It is necessary to avoid carelessly overcorrecting the driving force by a usual operation. In this embodiment, it is determined whether or not the vehicle speed (VSP) is more than the predetermined vehicle speed (VSPLO) at Step 1.

Next, it is determined whether or not the magnitude of the opening of the accelerator, that is, the state of the vehicle is in the neighborhood of the instability (ACCLO) at Step 2. (The vehicle speed is high and the state of the accelerator step (ACCLO) are detected at Steps 1 and 2). It is determined whether or not the rapid steering wheel operation (AngLIM) is performed under such a condition at Step 3. While the rapid steering operation is determined by the magnitude of the steering angle in the present invention, The change of the angle per unit time can be also used in a similar way. Flag FANG=1 of the rapid steering wheel operation is set at Step 4 when the steering angle is large at Step 3 in order to advice of the rapid steering wheel operation. The content of the correction control to the flag FANG will be described later.

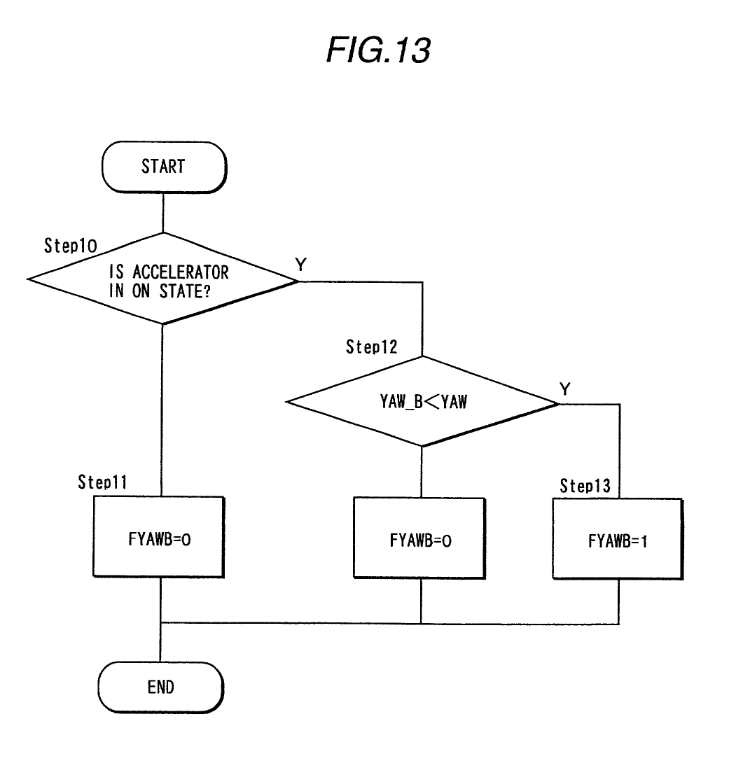

Next, another vehicle state determination will be explained with reference to FIG. 4. The turn movement of the vehicle is detected in this block. That is, the turn movement around the center of gravity of the vehicle, yaw movement, is detected. The details of the detection is shown in FIG. 13. When the vehicle does the yaw movement or turn movement, it is required to decrease the driving force and lead the movement of the vehicle in a direction of stability.

It is determined Whether or not the accelerator is stepped at Step10. Because the driving force is not basically output when the accelerator is not stepped, The processing is shifted to Step 11, the flag FYAWB=0 indicative of the presence or absence of the yaw movement is set, and the processing is terminated. The magnitude (YAWB) of the yaw movement is detected at Step 12, under the condition that the accelerator is stepped. FYAWB=1 indicative of the existence of the yaw movement is set at Step 13 when YAWB is more than the predetermined value (YAW).

Although details are described later, the correction of the direction of the decrease of the driving force from the viewpoint of the behavior of the vehicle is made in the blocks shown in FIG. 3 and FIG. 4. However, in the block shown in FIG. 5, the driving force is increased.

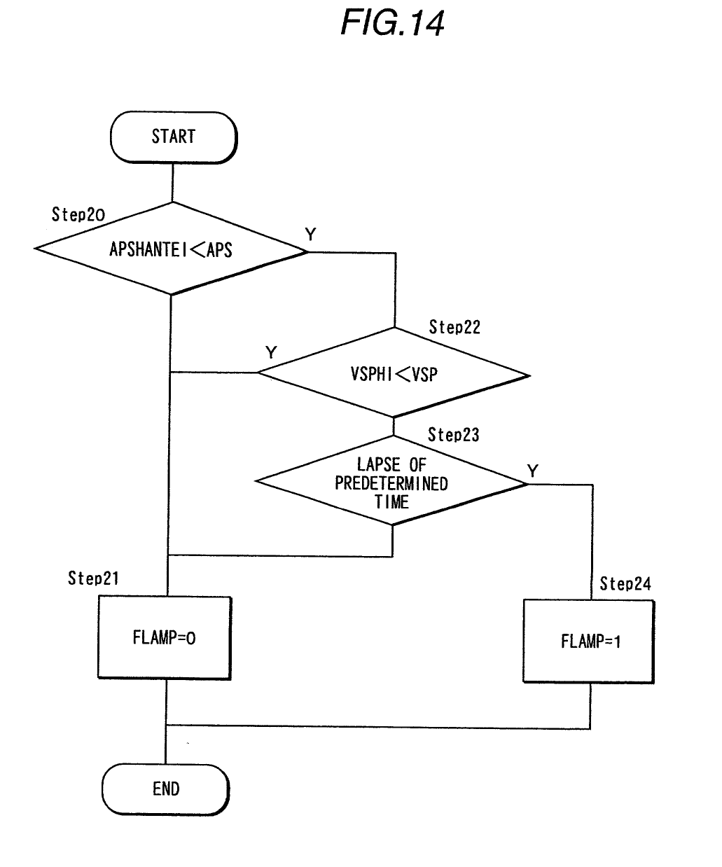

In FIG. 5, the vehicle speed and the opening of the accelerator are input to the vehicle state determination block (3). The driving force is corrected by determining whether or not the vehicle runs the slope. The detail of the block (3) is shown in FIG. 14.

Depressing level (APS) of the accelerator is determined at Step 20. If the APS is less than the predetermined value (APSHANTEI), it is determined that the vehicle is not in a specific running state, and a slope flag FLAMP=0 is set at Step 21. If the depressing level with the predetermined value is detected at Step 20, the vehicle speed (VPS) is determined at Step 22. If the vehicle speed exceeds the predetermined value (VSPHI), it is not determined that the vehicle runs the slope, because the vehicle speed corresponding to that occurred on the flat road is maintained. At Step 23, it is determined whether or not the accelerator is stepped and the state that the vehicle speed exceeded the predetermined value is continued for the predetermined time. For instance, if the vehicle runs constantly with the accelerator being stepped on the highway etc. and when the acceleration operation is done, the vehicle increases gradually its speed without accelerating instantaneously. That is, in the determination of the Step 23, there is the predetermined delay time to avoid a momentarily wrong determination. If it is detected at Step 23 that the predetermined vehicle speed is not maintained with the accelerator being stepped, it is determined that the vehicle runs the slope and FLAMP=1 indicative of the slope running is set at Step 24.

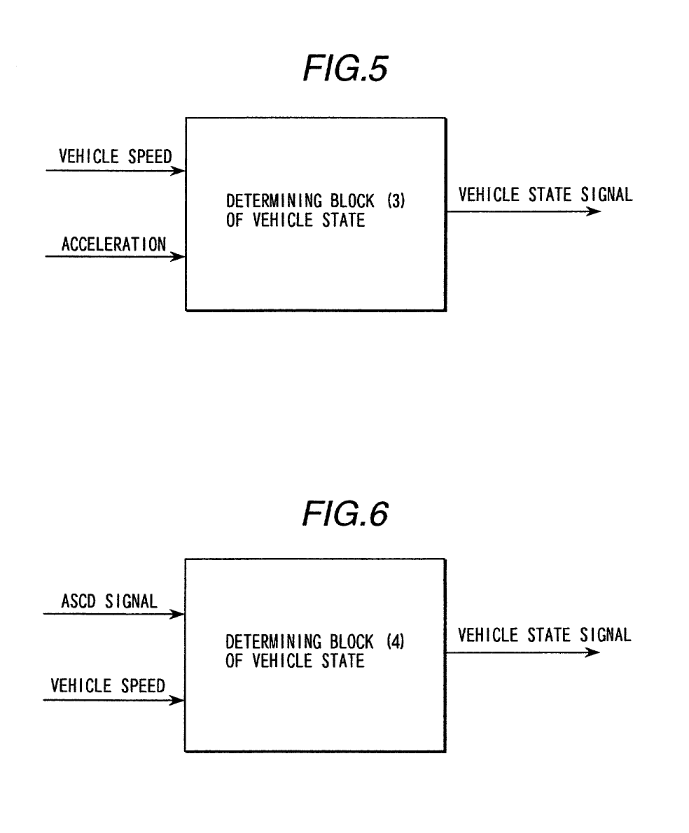

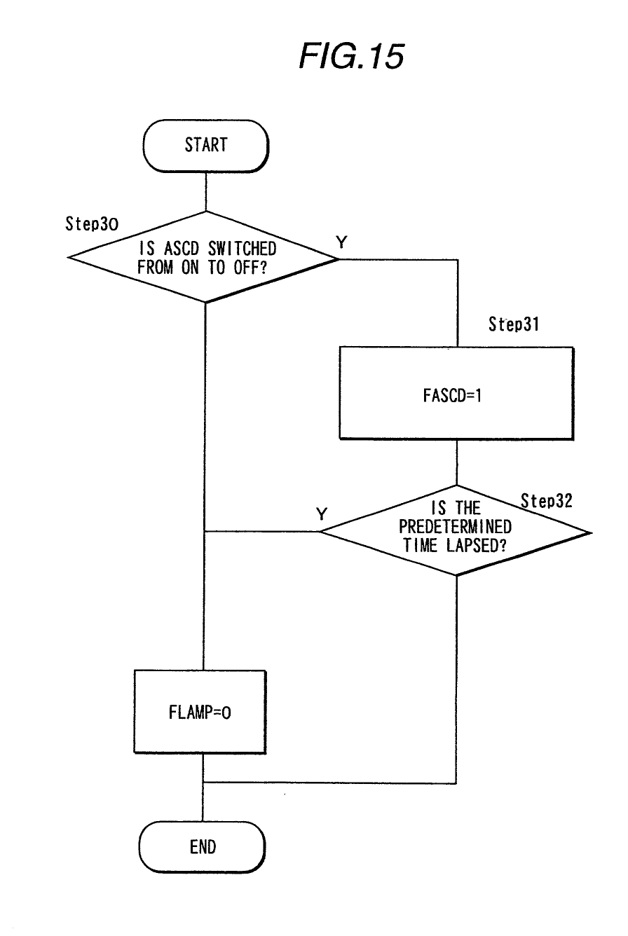

In the vehicle state determination block shown in FIG. 6, the driving force is corrected by the presence of operation of the controller called as an ASCD or constant cruise control. Therefore, the ASCD signal and other information are input to the determination block. Details of the determination operation will be explained with reference to FIG. 15.

It is determined not whether the vehicle is in the constant cruise control, but whether the constant cruise control is released in this block. The vehicle is controlled by ASCD for the vehicle speed to be constant in the state of ASCDOFF to ASCDON. Because the vehicle is controlled by the ASCD during the operation of the ASCD, it is not necessary to treat specially. In this embodiment, the final target driving force is prevented being rapidly changed immediately after changing from turning on into turning off.

More concretely, the turning off timing of the ASCD operation is detected at Step 30. ASCD operation flag is set to FASCD=1 as shown at Step 31 at the turning off. In addition, the elapsed time after the change of ON to OFF is measured at Step 32. ASCD operation flag is set to FASCD=0 after the lapse the predetermined time. That is, the driving force is controlled to be the target driving force immediately after the termination of ASCD, and in the course of the termination the excessive driving force is released for the predetermined time after the shift of ON to OFF.

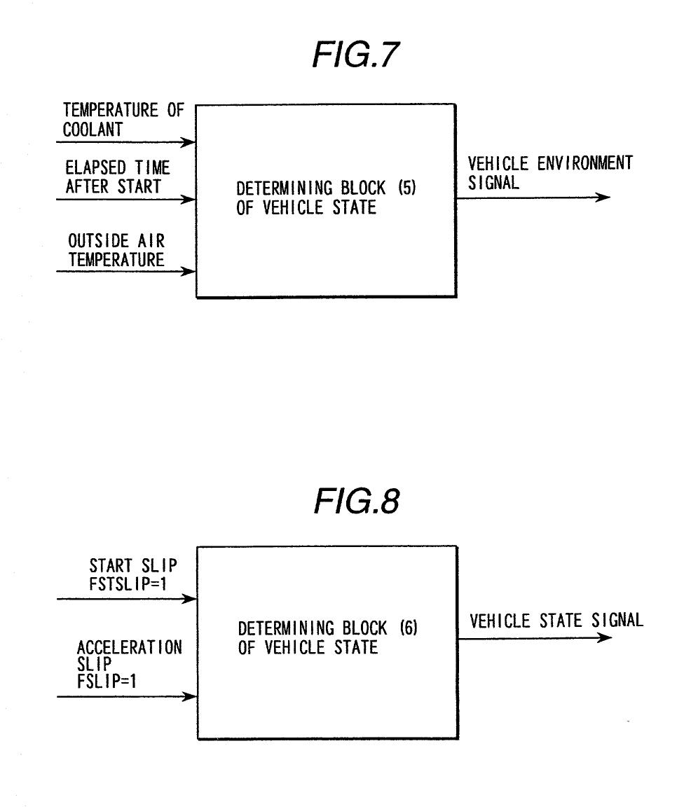

FIG. 7 shows another vehicle state determination block. An environmental condition of the vehicle is determined as a state of the vehicle in this block. In general, immediately after the cold start, etc., the friction of the engine lubrication system is normally larger enough than the state of the warm up, because the engine lubrication system is not warmed up enough. Therefore, when the same output (driving force) as the state of the warm up is demanded, the engine power should be made high naturally. When the state of the warm up of the engine advances in such a state, the driving force of the target driving force or more is generated. In this block, it has been evaded to become the above-mentioned state immediately after start.

The temperature of the engine cooling water is input to the determination block as a signal indicative of the state of the engine. Further, the outside air temperature is input as an environmental signal. Furthermore, the elapsed time after start is also input to the block.

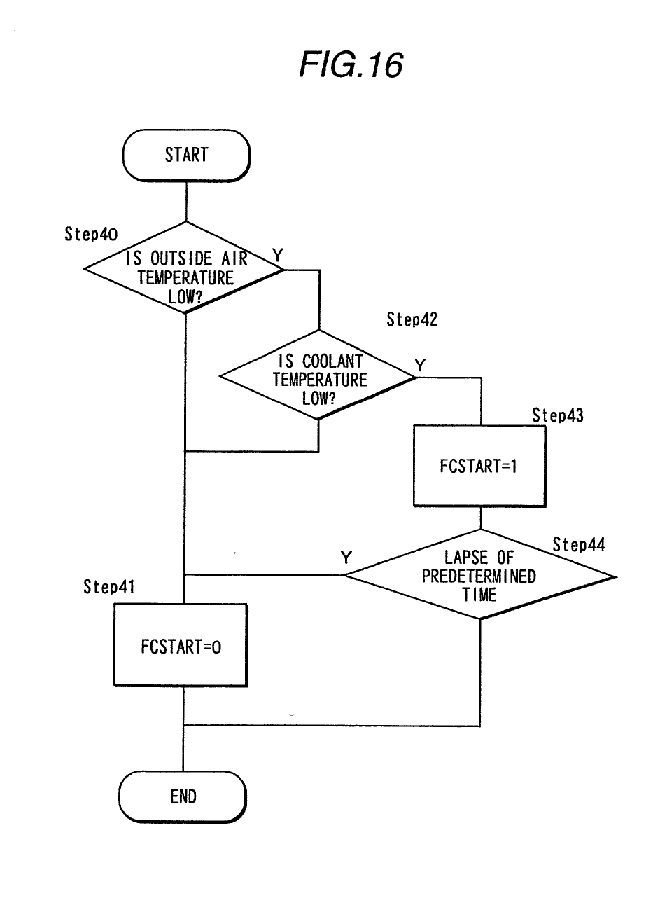

Details of the content of the determination are shown in FIG. 16.

The magnitude of the outside air temperature is determined at Step 40. If the outside air temperature is more than a predetermined temperature, flag FCSTART=0 is set not to perform the processing after start. Further, if the temperature of the engine cooling water is more than a predetermined temperature, FCSTART=0 is set at Step 41 even if the outside air temperature is lower.

If the cold start and the state of the low air temperature are detected at Steps 40 and 42, flag FCSTART=1 indicative of the state of the warm up after the cold start is set to advice of a special environment. Further, the elapsed time in the cold state is determined at step 44. After a predetermined time passes, a normal engine state determination is done at step 41.

Next, another vehicle state determination block will be explained with reference to FIG. 8.

The target driving force is corrected in this block along with the driving wheel slipping determination. The control of the driving wheel slipping is originally applied to the vehicle having traction control function (TCS). Further, the TCS is a function to squeeze the engine torque when slipping and to induce the vehicle in a direction of safety.

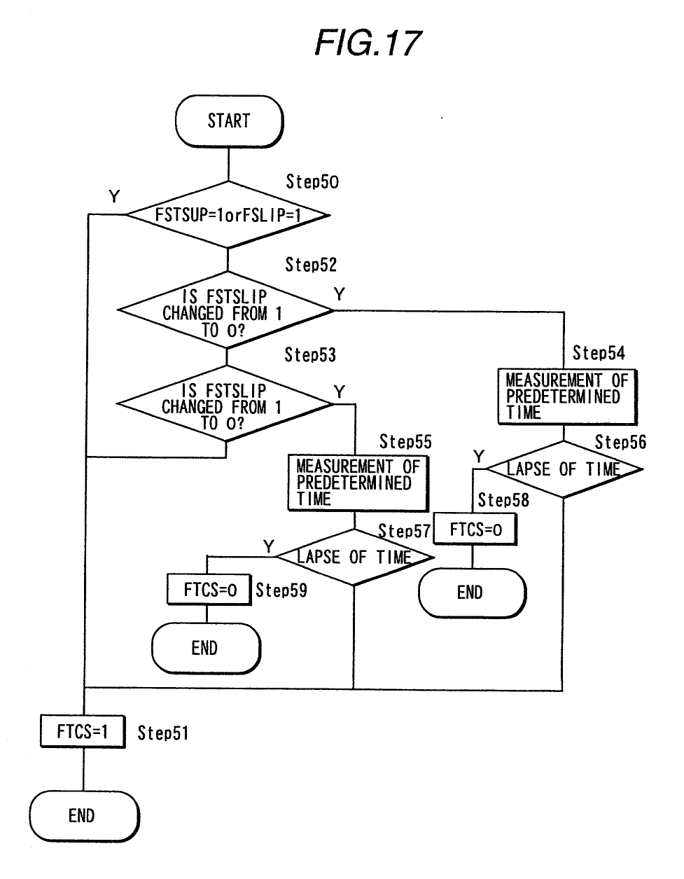

Although the driving force can be controlled by the function of the TCS when in the state of slipping, It is necessary to avoid applying rapid driving force immediately after the termination of the slipping by the TCS is determined. In the present invention, the driving force is controlled in a stable state, because the target driving force is decreased at the driving force control apparatus side during the predetermined time after the TCS is settled, as well as the case of above-mentioned ASCD. Therefore, while both the start acceleration and the acceleration slipping is input to this block, both of them may be determined as one state. However, because the form of the slipping is different between the start and acceleration, the settling determination time is separately provided respectively. Detail of the content of the determination is shown in FIG. 17.

The start or the acceleration slipping signal is determined at Step 50. This signal is received from the TCS unit 31. The slipping may be determined by engine control unit 15.

If the slipping determination signal is detected at Step 51, then flag FTCS=1 indicative of in-slipping is set at Step 51.

Next, it is determined to each slipping whether the settling determination was performed at Steps 52 and 53. The starting slipping is determined at Step 52, and the acceleration slipping is determined at Step 53.

When the start slipping flag FSTSLIP is changed from 1 into 0, the slipping settling is determined and the engine is returned to the normal output state. This is the same also in the acceleration slipping FSLIP.

The elapsed time after the slipping settling is measured respectively at Step 54 and 55, and the processing is stopped for the predetermined time. Afterwards, it is determined whether or not the predetermined time is elapsed at Step 56 and 57. After the predetermined time is elapsed, the FTCS=0 is set to advice of the recovery from the state of slipping and the return to the stationary state.

The predetermined time after TCS is settled here is time to stabilize the vehicle behavior by squeezing the driving force to avoid applying rapid driving force after the slipping is settled.

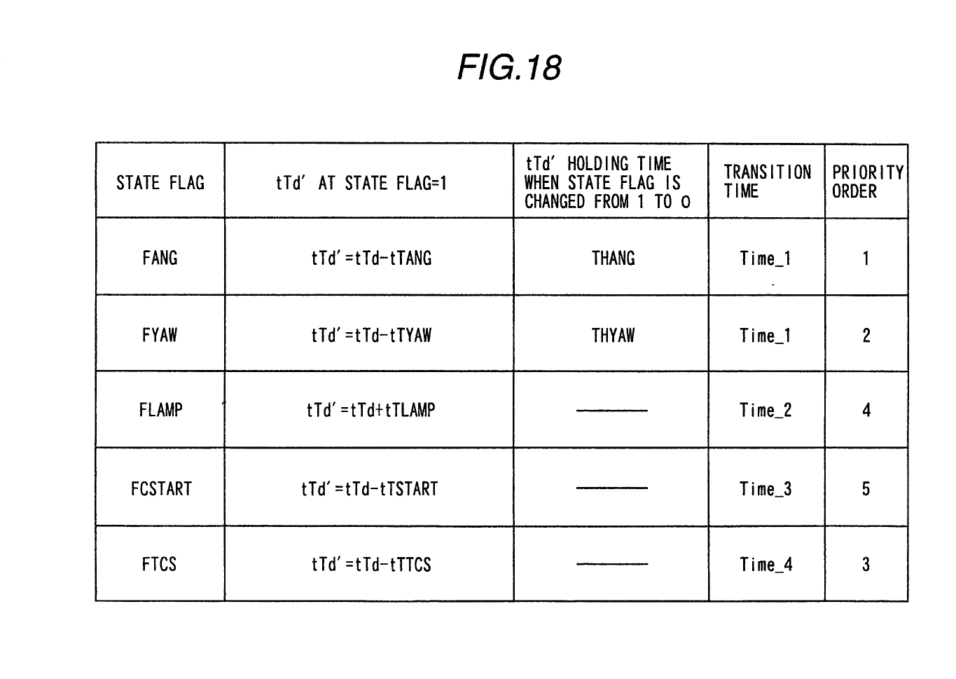

The detection and the determination of the vehicle state of FIG. 2 in the vehicle operating state determination block 41 have been described above. Next, the method of calculating the final target driving force tTd′ based on this vehicle operating state determination will be explained with reference to FIG. 2 and FIG. 18.

The determination result of the vehicle operating state determination block 41, and the target driving force obtained from the opening of the accelerator and the vehicle speed are calculated in the block 40, and input to the driving force distribution correction means block 42. A series of processing shown in FIG. 18 are performed in the block 42 based on the determination result of block 41.

First of all, the final driving force tTd′, an output of distribution correction means block 42 is calculated. This is obtained by subtracting or adding the driving force according to the vehicle state from or to basic driving force tTd as shown in FIG. 18. Normally, to lead the vehicle behavior in the direction of stability, the predetermined driving force according to the state is decreased from the basic driving force. However, to enable a smoother running when running the slope, the predetermined amount tTLAMP is added. It is not necessary to set the predetermined value to a fixed value. Preferably, it can be set according to each state level.

The method of calculating [tTd′ at the state flag=1] in FIG. 18 has been described above.

Next, [state flag=1→tTd′ holding time when changes] will be explained. This function is a function which maintains the driving force for the predetermined time until stabilized, without immediately recovering driving force after the change of the state, as shown in FIG. 17. Even if this function is included to the determination of state in the block 41 of FIG. 2, the effect is same. In this embodiment of the present invention, this function is included in this block at FANG (rapid steering wheel operation) and FYAW (yaw movement detection). However, because the vehicle is operated at more than the normal driving force when running up the slope, it is not preferable to give excessive driving force unnecessarily from the viewpoint of the vehicle behavior. Therefore, special holding time is not provided when running the slope, and it is normally shifted to the normal driving force immediately after the end of the slope, in the embodiment of the present invention.

Next, the [shift time] in the figure will be explained. This time is to prevent shock being generated at switch due to the difference of driving force when specific state is evaded and it is returned to the normal state of driving force control. The driving force is gradually recovered from the driving force tTd′ at that time toward basic driving force tTd within the transient time when a specific condition is evaded. Basic driving force tTd and final driving force tTd′ are equal to each other when it is regular, and the switching difference is decided according to the magnitude of the amount of the correction of a specific condition. Therefore, the transient time is set so as to correspond to the amount of the correction.

Next, the [priority level] in the figure decides the correction order when each operation is overlapped. Thereby, the interference between each correction control is avoided. The Priority level of which operation is raised is decided by the character of the vehicle characteristic and the vehicle, and not directly decided.

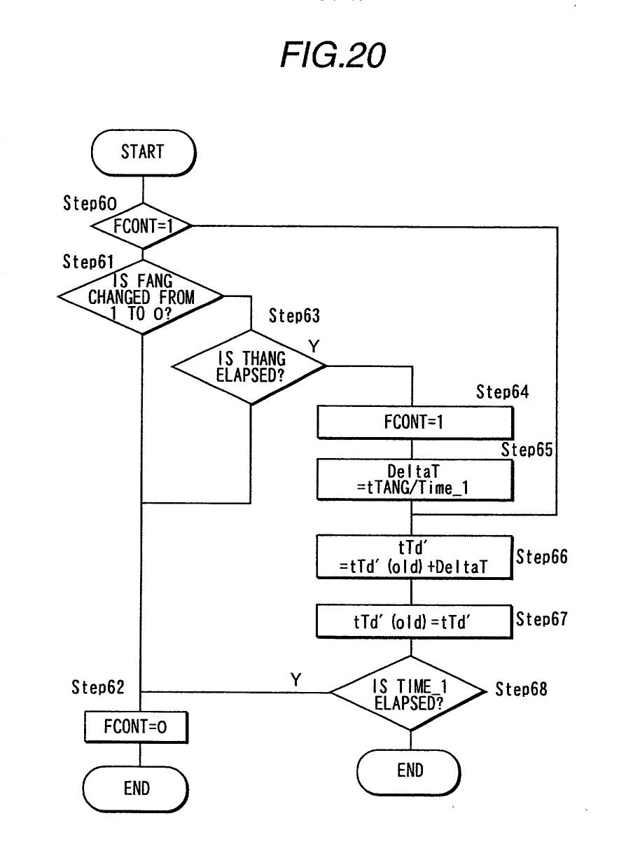

The state of the transient from this specific condition evasion to basic driving force will be explained with reference to FIG. 19 and FIG. 20.

FIG. 19 shows the state that the state of FANG is evaded. Because the rapid steering wheel operation is evaded, FANG=0 is set. Afterwards, such the state is maintained during the holding time THANG in change of state FANG1→0. Therefore, the final driving force tTd′ is controlled with tTANG corrected to basic driving force tTd. The transient control flag FCONT is set at the time of the passage of this holding time TGANG, and the basic driving force tTd decided from the target driving force map and the final driving force tTd′ are gradually connected within the predetermined time Time_{—}1. As a result, the switching shock is prevented. When the driving force shift ends by Time_{—}1, this control flag FCONT is cleared.

The actual processing is shown in FIG. 20. It is determined whether control the shift at Step 60. The evasion of the specific running condition is determined at step 61 when not is in the shift control.

If YES in the evasion determination, then the lapse of the stable time THANG is determined at step 63. When the lapse determination is done by this determination, the flag indicative of during-transient-control in FIG. 19 is set at Step 64. At Step 65, the amount of release of the correction per one control is calculated based on the correction amount tTANG and the transient time Time_{—}1. The amount of release obtained to last target driving force at Step 66 is added at Step 66, and the target driving force is shifted to a predetermined amount gradually.

Because FCONT=1 at Step 60 in the determination after second time, the processing jumps to Step 66, and the processing after Step 66 is continued. At Step 68, The lapse of the transitional time is determined. After the transitional time elapses, the control flag is set to FCONT=0 and the processing is terminated. Further, it is clear that a similar transition control is done also in the course of the transition from the normal driving force to the corrected driving force.

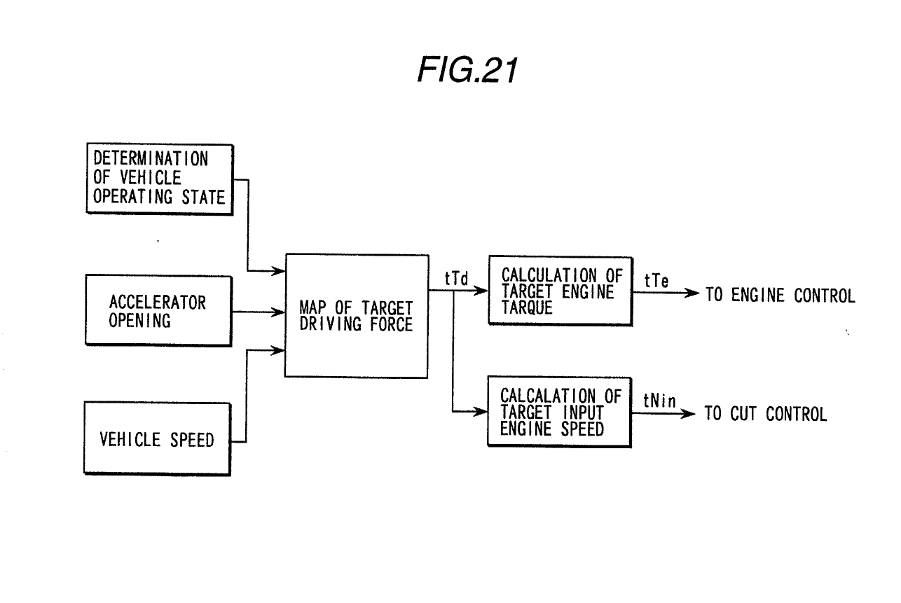

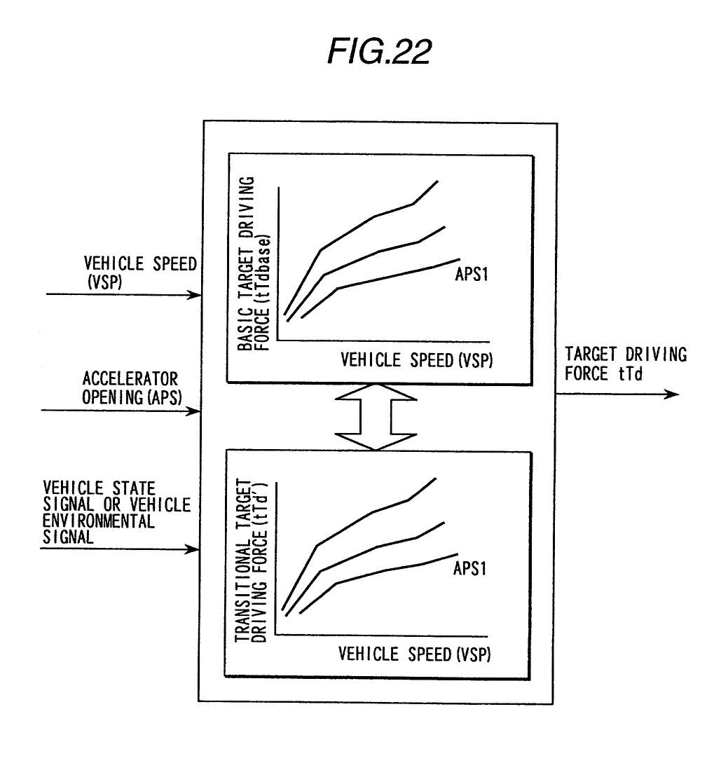

Another embodiment is shown in FIG. 21 and FIG. 22. As shown in FIG. 21, the result of the determination of vehicle operating state, the accelerator opening and vehicle speed are input to a map of target driving force. In practice, a plurality of target driving force maps are given as shown in FIG. 22. When the target driving force is decided, it is determined whether the normal driving force or the driving force under special condition. As a result, the driving force suitable to each condition can be obtained.

What is claimed is:

1. apparatus for controlling vehicle driving force comprising a target driving force deciding part for deciding a target driving force by using an accelerator opening and vehicle speed, and driving force distribution control part for distributing the target driving force to an engine torque control part and a drive system control part,
further comprising a vehicle running state determining part for detecting the running state of the vehicle,
wherein the result from said vehicle running state determining part is reflected to the correction control of the target driving force in said target driving force deciding part or the target driving force in said driving force distribution control part.

2. The apparatus for controlling vehicle driving force according to claim 1, wherein said correction control acts on said target driving force in a direction where said target driving force is increased or decreased when a special state is detected by said vehicle running state determining part, after avoiding the special state continues for a predetermined period of time, and is switched after transition time at the transition from or to the normal driving force.

3. The apparatus for controlling vehicle driving force according to claim 1, wherein said target driving force deciding part separately decides a target driving force used when a special state is detected by a vehicle running state determining part and the normal driving force, and interpolates both the target driving force at the switching of determination of the vehicle state.

4. The apparatus for controlling vehicle driving force according to any one of claims 1 to 3, wherein the state of steering change of the vehicle or the state of turn of the vehicle is determined by said vehicle running state determining part.

5. The apparatus for controlling vehicle driving force according to claim 4, wherein said turn of the vehicle is determined by using the signal of the yaw rate of the vehicle.

6. The apparatus for controlling vehicle driving force according to any one of claims 1 to 3, wherein the climbing state of the vehicle is determined by said vehicle running state determining part.

7. The apparatus for controlling vehicle driving force according to claim 1 or 2, wherein the ASCD end is determined by said vehicle running state determining part.

8. The apparatus for controlling vehicle driving force according to any one of claims 1 to 3, wherein the vehicle environment after start of the vehicle is determined by said vehicle running state determining part.

9. The apparatus for controlling vehicle driving force according to claim 8, wherein any one of the coolant temperature at start, the elapsed time after start, and the outside air temperature is used for the determination of vehicle environment.

10. The apparatus for controlling vehicle driving force according to any one of claims 1 to 3, wherein the wheel slip state is determined by said vehicle running state determining part.
